(19) United States
(12) Patent Application Publication
(10) Pub. No.: US 2009/0106464 A1
(43) Pub. Date: Apr. 23, 2009

(54) Interface Device for Printing From a Host to an Imaging Apparatus Having a Pictbridge Port

(76) Inventors: Barry Richard Cavill, Versailles, KY (US); John William Douglas, Lexington, KY (US); Brian Thomas Jones, Lexington, KY (US); Randy Allen O'Neal, Georgetown, KY (US); Harold Van de vere Putman, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/875,309

(22) Filed: Oct. 19, 2007

(51) Int. Cl. G06F 13/12

(52) U.S. Cl. 710/64

(57) ABSTRACT

An interface device is configured for printing from a host having a communications port to an imaging apparatus having a PictBridge port for receiving print data from a camera. The host includes an operating system having a spool subsystem. The interface device includes an input port configured to communicatively connect to the communications port; an output port configured to communicatively connect to the PictBridge port; and a controller interconnecting the input port and the output port. The controller is configured to execute program instructions to print from the host via the communications port to the imaging apparatus via the PictBridge port in real time using an output of the spool subsystem.

### CROSS REFERENCES TO RELATED APPLICATIONS

This patent application is related to the U.S. patent application Ser. No. 11/279,792, filed Apr. 14, 2006, entitled “Printing System And Interface Device Therefor” and assigned to the assignee of the present application.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Invention

The present invention relates generally to printing, and more particularly, to an interface device configured for printing from a host to an imaging apparatus having a PictBridge port.

2. Description of the Related Art

Users of host computer devices often have a need to print documents generated or modified on the host. Oftentimes, the host is a portable device, such as a personal laptop computer or a personal digital assistant (PDA), which are carried by the user from one location to another as a matter of course. In order to print a document, a print driver operating on the host is employed. Print drivers are typically printer dependent, and thus work on only certain particular printers or models/types of printers. In some cases, print drivers may work on classes of printers made by a particular manufacturer. If the user is at a location away from the user's normal places of printing, it may be that a printer is available for use, but the host lacks an adequate print driver, and thus, the user may be unable to print documents. Even if a print driver may be obtained, it may be inconvenient to load the print driver onto the host each time the user is at a different printer for which the host does not include a driver. Also, the storage of print drivers on the host takes up valuable storage space.

### SUMMARY OF THE INVENTION

The invention, in one form thereof, is directed to an interface device is configured for printing from a host having a communications port to an imaging apparatus having a PictBridge port for receiving print data from a camera. The host includes an operating system having a spool subsystem. The interface device includes an input port configured to communicatively connect to the communications port; an output port configured to communicatively connect to the PictBridge port; and a controller interconnecting the input port and the output port. The controller is configured to execute program instructions to print from the host via the communications port to the imaging apparatus via the PictBridge port in real time using an output of the spool subsystem.

The invention, in another form thereof, is directed to an interface device configured for printing from a host having a communications port to an imaging apparatus having a PictBridge port for receiving print data from a camera. The communications port and the PictBridge port have a same communications interface type. The host includes an operating system having a spool subsystem. The interface device includes a first port configured to communicatively connect to the communications interface; a second port configured to communicatively connect to the communications interface; and a controller interconnecting the first port and the second port. The controller is configured to execute program instructions to print from the host via the communications port to the imaging apparatus via the PictBridge port.

The invention, in yet another form thereof, is directed to a system configured to print from a host having a communications port to an imaging apparatus having a PictBridge port for receiving print data from a PictBridge compliant device. The system includes at least one of the host, the imaging apparatus and the PictBridge compliant data source; and an interface device. The interface device includes a first port configured to communicatively connect to the communications port; a second port configured to communicatively connect to the PictBridge port; and a controller having a data buffer interconnecting the first port and the second port. The controller is configured to execute program instructions to print from the host to the imaging apparatus via the first port, the data buffer and the second port

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 depicts a system having an interface device and configured to print from a host to an imaging apparatus having a PictBridge port;

FIGS. 2A and 2B depict an interface device in accordance with an embodiment of the present invention; and

FIG. 3 depicts an interface device in accordance with another embodiment of the present invention.

### DETAILED DESCRIPTION

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

In addition, it should be understood that embodiments of the invention include both hardware and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software. As such, it should be noted that a plurality of hardware and software-based devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible.

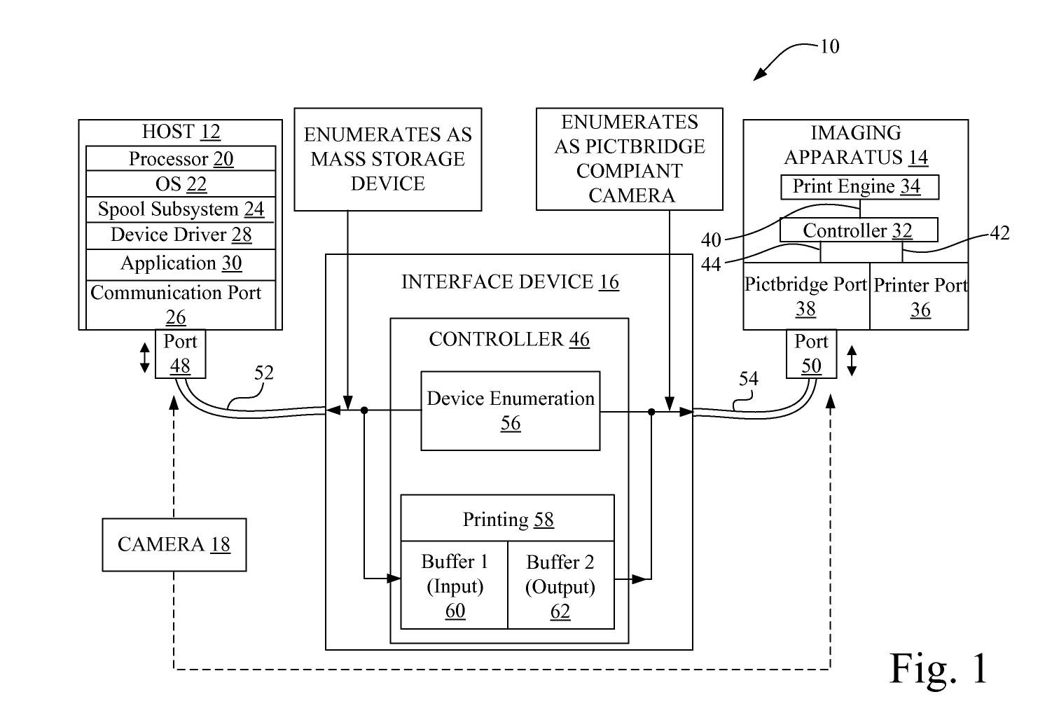

Referring now to FIG. 1, there is shown a system 10 in accordance with an exemplary embodiment of the present invention. System 10 may include a host 12, an imaging apparatus 14, and includes an interface device 16. In some embodiments, system 10 includes a PictBridge compliant device 18, such as a digital camera, in addition to host 12 and/or imaging apparatus 14, or instead of host 12 and/or imaging apparatus 14, which may be connected to either of host 12 and imaging apparatus 14, as illustrated by dashed lines.

Host 12 includes a processor unit 20, an operating system 22, such as WINDOWS® available from Microsoft Corporation, having a spool subsystem 24, and a communications port 26 for receiving or transmitting data to or from other electronic devices, i.e., an input/output (I/O) port. Host 12 may be, for example, a personal computer including, for example, a keyboard, mouse and display monitor. In other embodiments, host 12 may be, for example, a laptop computer or a personal digital assistant. Processor unit 20 of host 12 may include, for example, one or more microprocessors and associated memory, such as RAM, ROM, NVRAM, and a mass data storage device, such as a hard drive, CD-ROM and/or DVD units.

Operating on host 12 is a device driver 28 that is configured to print documents and other print jobs on imaging apparatus 14 via communications port 26 and interface device 16.

Host 12 is configured via hardware, firmware and/or software for running an application 30, e.g., a computer program such as a word processor, presentation software, or graphics software, on operating system 22. Using application 30, a user of host 12 may generate documents intended as print jobs which may be sent to a selected printer driver. An imaging driver takes the print job and typically converts the print data into a format compatible with an imaging apparatus selected to perform the printing operation.

With the present invention, the list of selectable printer device drivers available to a user includes device driver 28. In some embodiments, for example, host 12 may upload device driver 28 from a memory, storage device, or other computer readable medium storing an electronic copy of device driver 28, e.g., if device driver 28 does not already reside on host 12.

Unlike a conventional print driver, device driver 28 does not convert the print job to a format corresponding to a particular printer type, model or manufacturer. That is, device driver 28 is not imaging apparatus specific, but rather, is imaging apparatus independent. Rather than a format corresponding to a particular printer, device driver 28, converts the print job into print data in the form of an image file, such as a JPEG formatted 15 file, e.g., a JPEG print file that is outputted as JPEG image data through communications port 26. The term JPEG print file is intended to include both single and plural JPEG files. Although the present embodiment converts the print job to a JPEG file, other file types may be used without departing from the scope of the present invention, such as TIFF, XHTML-PRINT, and PNG file types. Accordingly, device driver 28 includes a set of program instructions for converting a print job generated by application 30 to an image file. In the present embodiment, device driver 28 is in the form of software, although it will be understood that in other embodiments of the present invention, device driver 28 may be in the form of any combination of software, firmware and/or hardware. In any event, device driver 28 is an imaging apparatus independent device driver configured for operation on operating system 22 to provide print data for the print job to communications port 26 using spool subsystem 24, and when employed in accordance with the present invention, may allow printing on any PictBridge capable imaging apparatus.

Device driver 28 may include instructions that allow a user to adjust the resolution of each print job, as well as the page size and margins of the document to be printed.

Imaging apparatus 14 includes a controller 32, a print engine 34, a printer port 36, and a PictBridge port 38. Imaging apparatus 14 may also include an operator panel (not shown). Imaging apparatus 14 may be, for example, any printing device such as color and black-and-white copiers, color and black-and-white printers, and so-called “all-in-one devices” that incorporate multiple functions such as scanning, copying, faxing and printing capabilities in one device. Controller 32 is communicatively coupled to print engine 34 via a communications link 40, to printer port 36 via a communications link 42, and to PictBridge port 38 via a communications link 44. As used herein, the term communications link is any suitable wired and/or wireless connections between two or more electronic components or devices.

Controller 32 may include, for example, a microprocessor unit and associated memory, and may be formed as an Application Specific Integrated Circuit (ASIC). Controller 32 executes program instructions to perform predefined tasks, such as for example, retrieving JPEG files via PictBridge Port 38, converting the JPEG files to formatted print data, and sending the formatted print data to print engine 34. Print engine 34 is configured to generate a printed output based on the formatted print data, and may utilize any of ink jet, dot matrix, dye sublimation, electrophotographic (e.g., laser), or any other suitable print technologies.

Data intended for printing may be received from an external device, such as host 12, via printer port 36 in an manner well know in the art, e.g., via a parallel or serial connection and an associated communication protocol. In addition, however, imaging apparatus 14 includes PictBridge port 38. PictBridge is an industry standard from the Camera & Imaging Products Association (CIPA) that allows images to be printed directly from PictBridge compliant devices, e.g., digital cameras, on a printer so equipped, without requiring the camera to be connected to a computer. Accordingly, PictBridge port 38 of imaging apparatus 14 is configured under the predefined standard for receiving input from a PictBridge compliant device 18, such as a digital camera, and permits printing of photographs downloaded from digital camera, with the aid of at least some user intervention, but without requiring connection to host 12.

Interface device 16 may be configured and constructed as a portable device. Interface device 16 includes a controller 46, a port 48 and a port 50. In the present embodiment, each of communications port 26, PictBridge port 38, port 48 and port 50 are in the form of a bi-directional communications interface, e.g., a universal serial bus (USB) port. Also, in the present embodiment, each of port 48 and port 50 employ a USB-A connector, and hence, each may be plugged into and communicatively connected to either of communications port 26 and PictBridge port 38. In order to enhance user experience, as well as to reduce package size and cost, interface device 16 is a USB powered device. Alternatively, it is considered that interface device 16 may be powered by, for example, a battery or an external power source.

Controller 46 is communicatively coupled to port 48 via a communication link 52 and to port 50 via communication link 54. Controller 46 includes a device enumeration portion 56, and a printing portion 58 having a buffer 60 and a buffer 62 that interconnect port 48 and port 50. Buffer 60 is coupled to port 48 via communications link 52, and buffer 62 is coupled to port 50 via communications link 54. Controller 46 thus interconnects port 48 and port 50, and is configured, e.g., via hardware, firmware and/or software to execute program instructions to print from host 12 via communications port 26 to imaging apparatus 14 via PictBridge port 38 in real time using the output of spool subsystem 24. During a printing operation, the print job data is directed by controller 46 from port 48 to buffer 60, to buffer 62, and then to port 50, where the data is then received by PictBridge port 38.

Controller 46 is configured to respond to device inquiries from both host 12 and imaging apparatus 14, and to identify interface device 16 to host 12 as a one device type, and identify interface device 16 to imaging apparatus 14 as a second device type, i.e., another type of device. In particular, controller 46 is configured for device enumeration using device enumeration portion 56, which in the present embodiment enumerates interface device 16 to host 12 as a mass storage device, and enumerates interface device 16 to imaging apparatus 14 as a PictBridge compliant device. Stated differently, interface device 16 appears to host 12 as a mass storage device, and appears to imaging apparatus 14 as a PictBridge compliant device, e.g., in the form of a digital camera, that is in PictBridge mode. However, it will be understood that interface device 16 may enumerate to host 12 and/or imaging apparatus 14 as other device types without departing from the scope of the present invention.

Controller 46 is also configured to execute program instructions to provide dual polarity support for interface device 16. That is, controller 46 is configured to print from host 12 via communications port 26 to imaging apparatus 14 via PictBridge port 38 when port 48 is communicatively connected to communications port 26 and port 50 is communicatively connected to PictBridge port 38, and also when port 50 is communicatively connected to communications port 26 and port 48 is communicatively connected to PictBridge port 38. For example, once ports 48 and 50 are connected to host 12 and imaging apparatus 14, enumeration may be accomplished by host 12 recognizing via device driver 28 the USB Device ID of interface device 16 when one of ports 48 and 50 is connected to communications port 26. Host 12 may then send a command, such as a vendor specific command, to interface device 16, which may be employed to identify to interface device 16 which of ports 48 and 50 is connected to host 12, and hence, which is connected to imaging apparatus 14. In one exemplary embodiment, interface device 16 may initially enumerate to both host 12 and imaging apparatus 14 as a PictBridge device, and upon receiving a command from host 12, interface device 16 may then re-enumerate to host 12 as another device type, such as a mass storage device.

In the present embodiment, interface device 16 is memoryless. That is, interface device 16 does not employ a storage memory or a mass data storage device to store a print job for later transmission to imaging apparatus 14. Rather, controller 46 is configured to execute program instructions to perform data buffering between host 12 and imaging apparatus 14, and interface device 16 transfers the data in real time by pacing the print job data with data buffers, such as buffers 60 and 62.

In operation, when one of the ports 48 and 50 is connected to the communications port 26, interface device 16 of the present embodiment enumerates as a mass storage device, and when the other cable is connected to the printer, interface device 16 enumerates as a PictBridge compliant camera operating in PictBridge mode. When a user prints documents through device driver 28, device driver 28 formats the print data as a series of JPEG images, e.g., one image per document page, and sends the data to interface device 16 using commands appropriate for the device type enumerated by interface device 16 to host 12, which in the present embodiment is a mass storage device. Controller 46 of interface device 16 then translates and transmits the data to imaging apparatus 14 using commands appropriate for the device type enumerated by interface device 16 to imaging apparatus 14, which in the present embodiment is a PictBridge compliant camera. Interface device 16 is a real-time printing connection device, and from the user perspective, appears to operate in a similar nature as printing via a USB cable to a printer port 36, permitting the user to connect a computer directly to the printer PictBridge port, and allowing the user to print, e.g., documents, photo images, etc., in a familiar fashion. The user's printing experience using interface device 16 is just like printing over a normal USB cable, except that a printer driver capable of communicating with interface device 16, i.e., device driver 28, by virtue of the present invention enables printing to any industry-standard PictBridge compliant printer without requiring unique printer drivers. This may provide the industry with a universal printer driver capability.

Being a transfer device, interface device 16 has no inherent storage limitations, and employs data buffers, e.g., buffer 60 and buffer 62, which allow data to flow from host 12 through interface device 16 to imaging apparatus 14. As the imaging apparatus 14 begins printing the photo or document, interface device 16 provides data pacing via the transfer buffers 60 and 62. By virtue of the present invention, data flows from host 12 to interface device 16 to the imaging apparatus 14 in a similar manner to a traditional cable connected printer. Thus, with the present invention, there may be no limitations to the number of pages, print image quality, or the number of print jobs which interface device 16 may support. In addition, interface device 16 does not require custom header files, and thus does not duplicate various facets of operating system 22, but rather, it relies upon the spool subsystem 24 to perform the printing operations.

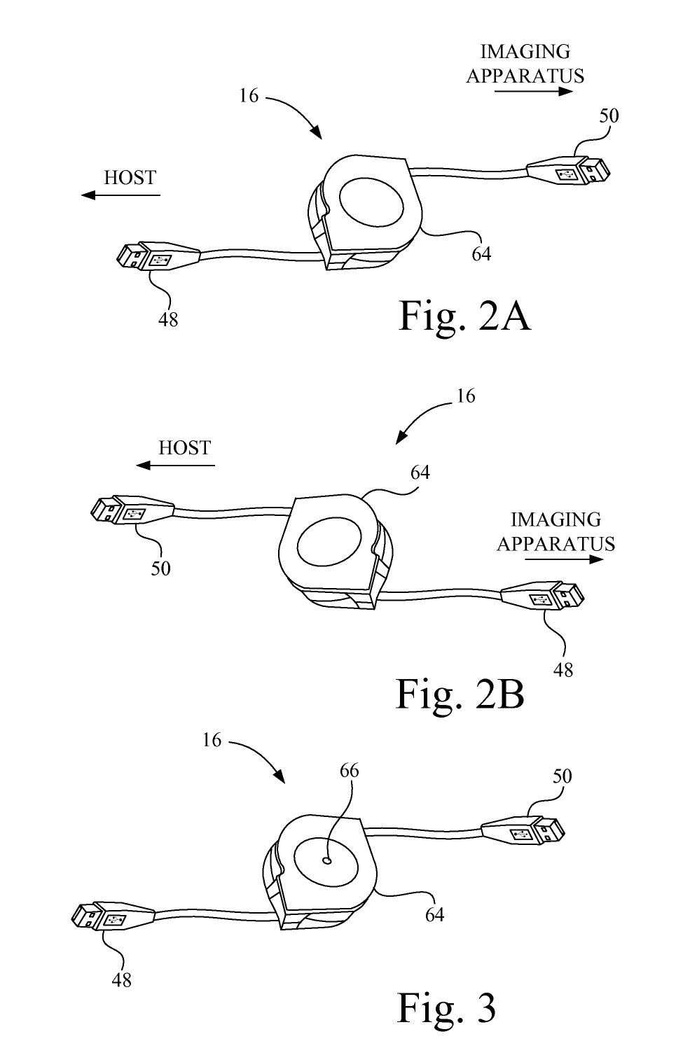

Referring now to FIGS. 2A and 2B, an embodiment of interface device 16 includes a retractable cable system 64 housing and interconnecting controller 46 (not shown in the figures), port 48 and port 50, which may enhance the user experience with interface device 16 by providing a compact structure. Because interface device 16 is a dual-polarity device, the user may plug either of ports 48 and 50 into communications port 26 and the other of ports 48 and 50 into PictBridge port 38, in any order, and the print data will flow from host 12, through the buffers 60 and 62 in a data flow direction from the port connected to host 12, to the port connected to imaging apparatus 14.

Referring now to FIG. 3, an embodiment of interface device 16 also includes a visual indicator 66 configured to indicate that there is data traffic flowing through interface device 16. In the present embodiment, visual indicator 66 is in the form of an LED that lights up to indicate the presence of data traffic. In other embodiments, visual indicator 66 may take the form of multiple LEDs or a multicolor LED that may separately indicate connection to host 12, imaging apparatus 14, and the presence of data traffic. For example, one color may represent connection to one of host 12 and imaging apparatus 14, a second color may indicate subsequent connection to the other of host 12 and imaging apparatus 14, and a third color may represent the presence of data traffic. A small OLED display may also be used to serve as a visual indicator to provide this information to a user by displaying graphical images and text.

The foregoing description of embodiments of the invention has been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

What is claimed is:

1. An interface device configured for printing from a host having a communications port to an imaging apparatus having a PictBridge port for receiving print data from a camera, said host including an operating system having a spool subsystem, comprising:
an input port configured to communicatively connect to said communications port;
an output port configured to communicatively connect to said PictBridge port; and
a controller interconnecting said input port and said output port, said controller being configured to execute program instructions to print from said host via said communications port to said imaging apparatus via said PictBridge port in real time using an output of said spool subsystem.

2. The interface device of claim 1, wherein said controller is further configured to:
identify said interface device to said host as a first device type; and
identify said interface device to said imaging apparatus as a second device type different than said first device type.

3. The interface device of claim 1, wherein said interface device is memoryless.

4. The interface device of claim 3, wherein said controller is further configured for device enumeration.

5. The interface device of claim 4, wherein said controller is further configured to:
enumerate said interface device to said host as a mass storage device; and
enumerate said interface device to said imaging apparatus as a PictBridge compliant device.

6. The interface device of claim 3, said controller including:
a first buffer coupled to said input port; and
a second buffer coupled to said first buffer and said output port,
wherein said interface device is configured to direct said print data directly from: said input port to said first buffer; from said first buffer to said second buffer; and from said second buffer to said output port.

7. The interface device of claim 1, wherein said communications port is a first USB port and said PictBridge port is a second USB port, and wherein said input port employs a first USB-A connector and said output port employs a second USB-A connector.

8. The interface device of claim 1, further comprising a computer readable medium storing an imaging apparatus independent device driver configured for operation on said operating system of said host to provide said print data to said communications port using said spool subsystem.

9. The interface device of claim 8, wherein said device driver is configured to print in the form of JPEG image data.

10. The interface device of claim 1, further comprising a retractable cable system interconnecting said controller, said input port and said output port.

11. The interface device of claim 1, further comprising a visual indicator configured to indicate a data traffic through said interface device.

12. The interface device of claim 1, wherein said controller is configured to respond to device inquiries from both said host and said imaging apparatus.

13. An interface device configured for printing from a host having a communications port to an imaging apparatus having a PictBridge port for receiving print data from a camera, said communications port and said PictBridge port having a same communications interface type, said host including an operating system having a spool subsystem, comprising:
a first port configured to communicatively connect to said communications interface;
a second port configured to communicatively connect to said communications interface; and
a controller interconnecting said first port and said second port, said controller being configured to execute program instructions to print from said host via said communications port to said imaging apparatus via said PictBridge port.

14. The interface device of claim 13, said controller being further configured to execute said program instructions to provide dual polarity support for said interface device, wherein said controller is configured to execute said program instructions to print from said host via said communications port to said imaging apparatus via said PictBridge port when said first port is communicatively connected to said communications port and said second port is communicatively connected to said PictBridge port, and when said second port is communicatively connected to said communications port and said first port is communicatively connected to said PictBridge port.

15. The interface device of claim 13, wherein said interface device is memoryless.

16. The interface device of claim 13, further comprising a data buffer, wherein said controller is configured to execute said program instructions to perform data buffering between said host and said imaging apparatus.

17. A system configured to print from a host having a communications port to an imaging apparatus having a PictBridge port for receiving print data from a PictBridge compliant device, said system comprising:
at least one of said host, said imaging apparatus and said PictBridge compliant data source; and
an interface device, the interface device including:
a first port configured to communicatively connect to said communications port;
a second port configured to communicatively connect to said PictBridge port; and
a controller having a data buffer interconnecting said first port and said second port, said controller being configured to execute program instructions to print from said host to said imaging apparatus via said first port, said data buffer and said second port.

18. The interface device of claim 17, said controller being further configured to execute said program instructions to provide dual polarity support for said interface device, wherein said controller is configured to execute said program instructions to print from said host via said communications port to said imaging apparatus via said PictBridge port when said first port is communicatively connected to said communications port and said second port is communicatively connected to said PictBridge port, and when said second port is communicatively connected to said communications port and said first port is communicatively connected to said PictBridge port.

19. The interface device of claim 17, wherein said interface device is memoryless.

20. The interface device of claim 17, wherein said controller is further configured to execute said program instructions to:
identify said interface device to said host as a first device type; and
identify said interface device to said imaging apparatus as a second device type different than said first device type.
